(19) United States
(12) Patent Application Publication
(10) Pub. No.: US 2026/0158934 A1
(43) Pub. Date: Jun. 11, 2026

(54) MOTOR-ACCELERATION BASED SPIN UP CONTROL

(71) Applicant: Atieva, Inc., Newark, CA (US)

(72) Inventors: Fabrice Anthony Paccoret, Fremont, CA (US); Hung-Yen Ou Yang, Newark, CA (US); Ruxiao An, Sunnyvale, CA (US); Aditya Chetty, Fremont, CA (US)

(21) Appl. No.: 18/703,970

(22) PCT Filed: Oct. 27, 2022
(86) PCT No.: PCT/US2022/078815

§ 371 Date: Apr. 23, 2024

Related U.S. Application Data
(60) Provisional application No. 63/263,197, filed on Oct. 28, 2021.

(51) Int. Cl. B60L 15/20

(52) U.S. Cl. CPC B60L 15/20; B60L 2240/421; B60L 2240/423

(57) ABSTRACT

In a general aspect, a method includes determining, by a motor controller, an angular acceleration of an electric motor of a vehicle, and determining, by the motor controller, an angular speed of the electric motor. The method also includes receiving, by the motor controller, a torque command indicating an amount of torque requested from the electric motor. The method further includes, in response to the angular acceleration exceeding a first threshold, the angular speed being non-zero, and the amount of torque requested by the torque command being non-zero: determining a torque compensation amount based on a difference between an acceleration limit and the angular acceleration; subtracting the torque compensation amount from the amount of torque requested by the torque command to generate a compensated torque command; and controlling an amount of torque generated by the electric motor using the compensated torque command.

### CROSS-REFERENCE TO RELATED APPLICATION

This application claims the priority benefit of U.S. Provisional Application No. 63/263,197, entitled “MOTOR-ACCELERATION BASED SPIN UP CONTROL”, filed Oct. 28, 2021, the disclosure of which is hereby incorporated by reference in its entirety.

### TECHNICAL FIELD

This document relates to spin up control in electric vehicles based on motor speed acceleration.

### BACKGROUND

In recent years, electric vehicle (EV) technology has continued to develop, and an increasing number of people are choosing to have an EV as a personal vehicle. Motors used in EVs (e.g., permanent magnet motors, induction motors, etc.) have fast torque dynamics. Such torque dynamics can cause vehicle wheel slip relative to a driving surface, which can cause loss of traction, adversely impact vehicle drivability and, in some instances, can cause traction related safety concerns.

### SUMMARY

In a general aspect, a method includes determining, by a motor controller, an angular acceleration of an electric motor of a vehicle, and determining, by the motor controller, an angular speed of the electric motor. The method also includes receiving, by the motor controller, a torque command indicating an amount of torque requested from the electric motor. The method further includes, in response to the angular acceleration exceeding a first threshold, the angular speed being non-zero, and the amount of torque requested by the torque command being non-zero: determining a torque compensation amount based on a difference between an acceleration limit and the angular acceleration, subtracting the torque compensation amount from the amount of torque requested by the torque command to generate a compensated torque command; and controlling an amount of torque generated by the electric motor using the compensated torque command.

Implementations can include one or more of the following features, or any combination thereof. For example, a numeric sign for the torque compensation amount can be based on a numeric sign of the amount of torque requested by the torque command.

Determining the torque compensation amount can include determining the torque compensation amount using a proportional integral controller that is configured to implement a regulator controller.

The regulator controller can be enabled in response to all of: the angular acceleration exceeding the first threshold; the angular speed being greater than zero; and the amount of torque requested by the torque command being greater than zero.

The regulator controller can be enabled in response to all of: an absolute value of the angular acceleration exceeding the first threshold; the angular speed multiplied by the amount of torque requested by torque command being greater than zero; and the angular acceleration multiplied by the amount of torque requested by the torque command being greater than zero.

The regulator controller can be disabled in response to one or more of: the angular acceleration being less than a second threshold, the second threshold being less than the first threshold; the angular speed being greater than less than or equal to zero; or the amount of torque requested by the torque command being less than or equal to zero.

The regulator controller can be disabled in response to one or more of: an absolute value of the angular acceleration being less than a second threshold, the second threshold being less than the first threshold; the angular speed multiplied by the amount of torque requested by the torque command being greater than less than or equal to zero; or the angular acceleration multiplied by the amount of torque requested by the torque command being less than or equal to zero.

An absolute value of the torque compensation amount can be between zero and a torque compensation limit greater than zero.

In another general aspect, a vehicle includes an electric motor, and a motor controller. The motor controller is configured to determine angular acceleration of the electric motor of a vehicle, determine an angular speed of the electric motor, and receive a torque command indicating an amount of torque requested from the electric motor. In response to the angular acceleration exceeding a first threshold, the angular speed being non-zero, and the amount of torque requested by the torque command being non-zero, the motor controller is configured to determine a torque compensation amount based on a difference between an acceleration limit and the angular acceleration, subtract the torque compensation amount from the amount of torque requested by the torque command to generate a compensated torque command, and control an amount of torque generated by the electric motor using the compensated torque command.

Implementations can include one or more of the following features, or any combination thereof. For example, a numeric sign for the torque compensation amount can be based on a numeric sign of the amount of torque requested by the torque command.

The motor controller can include a proportional integral controller configured to determine the torque compensation amount. The proportional integral controller can implement a regulator controller.

The proportional integral controller can be enabled in response to all of: the angular acceleration exceeding the first threshold; the angular speed being greater than zero; and the amount of torque requested by the torque command being greater than zero.

The proportional integral controller can be enabled in response to all of: an absolute value of the angular acceleration exceeding the first threshold; the angular speed multiplied by the amount of torque requested by torque command being greater than zero; and the angular acceleration multiplied by the amount of torque requested by the torque command being greater than zero.

The proportional integral controller can be disabled in response to one or more of: the angular acceleration being less than a second threshold, the second threshold being less than the first threshold; the angular speed being greater than less than or equal to zero; or the amount of torque requested by the torque command being less than or equal to zero.

The proportional integral controller can be disabled in response to one or more of: an absolute value of the angular acceleration being less than a second threshold, the second threshold being less than the first threshold; the angular speed multiplied by the amount of torque requested by the torque command being greater than less than or equal to zero; or the angular acceleration multiplied by the amount of torque requested by the torque command being less than or equal to zero.

An absolute value of the torque compensation amount can be between zero and a torque compensation limit greater than zero.

### BRIEF DESCRIPTION OF DRAWINGS

FIG. 1 shows an example of a vehicle.

FIG. 2 shows an example of evaluating vehicle operating conditions for enabling or disabling spin up control that can be performed by the motor controller of FIG. 1.

FIG. 3 shows an example of a spin up control process that can be performed by the motor controller of the vehicle in FIG. 1.

FIG. 4 shows another example of evaluating vehicle operating conditions for enabling or disabling spin up control that can be performed by the motor controller of FIG. 1.

FIG. 5 shows another example of a spin up control process that can be performed by the motor controller of the vehicle in FIG. 1.

Like reference symbols in the various drawings indicate like elements.

### DETAILED DESCRIPTION

This document describes examples of systems and techniques for spin up control in a vehicle, e.g., an electric vehicle (EV). In example implementations, a motor control unit can implement a motor control strategy that includes adjusting the requested torque from the powertrain to prevent wheel slip.

Examples described herein refer to a vehicle. A vehicle is a machine that transports passengers or cargo, or both. A vehicle can have one or more motors using at least one type of fuel or other energy source (e.g., electricity). Examples of vehicles include, but are not limited to, cars, trucks, and buses. The number of wheels can differ between types of vehicles, and one or more (e.g., all) of the wheels can be used for propulsion of the vehicle. The vehicle can include a passenger compartment accommodating one or more persons. An EV can be powered exclusively by electricity, or can use one or more other energy sources in addition to electricity, such as petroleum, diesel fuel, or natural gas, to name just a few examples. As used herein, an EV includes an onboard energy storage, sometimes referred to as a battery pack, to power one or more electric motors. Two or more EVs can have different types of energy storages and/or different sizes thereof.

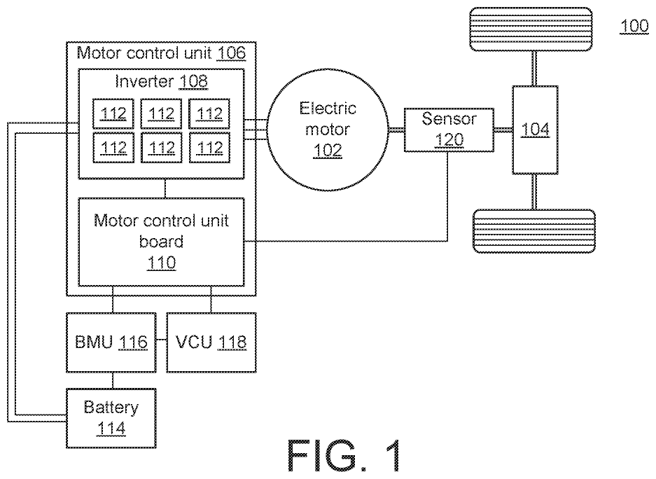

FIG. 1 shows an example of a vehicle 100 having an electric motor (motor) 102. Depending on the implementation, the motor 102 can be a permanent magnet motor, an induction motor, etc. In this example, the motor 102 and/or other components of the vehicle 100 can be used with one or more other examples described elsewhere herein. Only portions of the vehicle 100 are shown, for simplicity. The motor 102 can generate torque for one or more drive wheels. In some implementations, gears 104 can be provided between the motor 102 and the drive wheel(s). For example, the gears 104 can include a differential and/or can provide gear reduction.

The vehicle 100 can use a motor controller to operate the motor 102 as well as other components. Here, the vehicle 100 includes a motor control unit (MCU) 106 that includes an inverter 108 and an MCU board 110. The MCU board 110 controls the inverter 108. The MCU board 110 can include one or more processing components. In some implementations, the MCU board 110 includes one or more processors. For example, the MCU board 110 can also include one or more field-programmable gate arrays. The MCU 106 can also include one or more other components for controlling the motor 102. For example, gate drivers, shunt monitors, and cooling features can be included.

The inverter 108 can include one or more power stages to convert direct current (DC) to alternating current (AC) to drive the motor 102. In some implementations, the inverter 108 can also be used convert AC to DC when recovering energy from the motor 102. The inverter 108 can use transistors 112 that are toggled on and off repeatedly to generate AC for, or recover energy from, the motor 102. In some implementations, six of the transistors 112 can be coupled in respective pairs to produce three-phase AC. The transistors 112 can be metal-oxide semiconductor field-effect transistors (MOSFETs). For example, silicon carbide MOSFETs can be used. In other implementations, insulated-gate bipolar transistors (IGBTs), or other types of transistors can be used.

The vehicle 100 includes a battery 114. The battery 114 can include one or more modules of electrochemical cells. For example, lithium-ion cells can be used. The battery 114 can be controlled by a battery management unit (BMU) 116. For example, the BMU 116 can manage the state of charge of the battery 114, and open and close the contactors between the battery 114 and the inverter 108. The battery 114 which is the energy source for vehicle propulsion can be referred to as a high-voltage battery to distinguish it from a low-voltage (e.g., 12 V) battery that can power one or more components (e.g., the MCU board 110).

The vehicle 100 includes a vehicle control unit (VCU) 118. The VCU 118 can control the operational state of the vehicle 100. In some implementations, the VCU 118 can be coupled to both the BMU 116 and the MCU board 110. For example, the VCU 118 can generate and/or coordinate torque requests regarding the motor 102, such as generating a vehicle torque command based on a driver depressing an accelerator pedal. Using the approaches described herein, such torque requests (e.g., vehicle torque command) can be adjusted in order to reduce or prevent wheel slip and/or loss of traction due to the fast torque dynamics of the motor 102.

The vehicle 100 includes a sensor 120 that can indicate a rotational position of the rotor in the motor 102. In some implementations, the sensor 120 can be mounted to the shaft of the rotor and can give angle measurements. Using these angle measurements, the MCU 106 can determine rotational speed of the motor. For example, the sensor 120 can include analog circuitry (e.g., a resolver) or digital circuitry (e.g., an encoder). Further, based on the rotational speed of the motor, motor acceleration (e.g., angular acceleration) can be determined, such as by taking a derivative of two consecutive motor speed measurements or calculations.

The vehicle 100 can execute a motor control strategy during operation of (e.g., when driving) the vehicle 100. This motor control strategy can include spin up control associated with operation of the motor 102, e.g., during vehicle acceleration. In implementations, such spin up control can be implemented based on angular motor speed acceleration and an amount of torque requested (e.g., by the VCU 118). Using the approaches described herein, an amount of torque request from the motor 102 can be adjusted (e.g., reduced) to reduce or prevent wheel slippage relative to a driving surface of the vehicle 100. For instance, in example implementations, spin up control can be implemented in response to an amount of requested torque exceeding a spin up control torque limit for the vehicle 100.

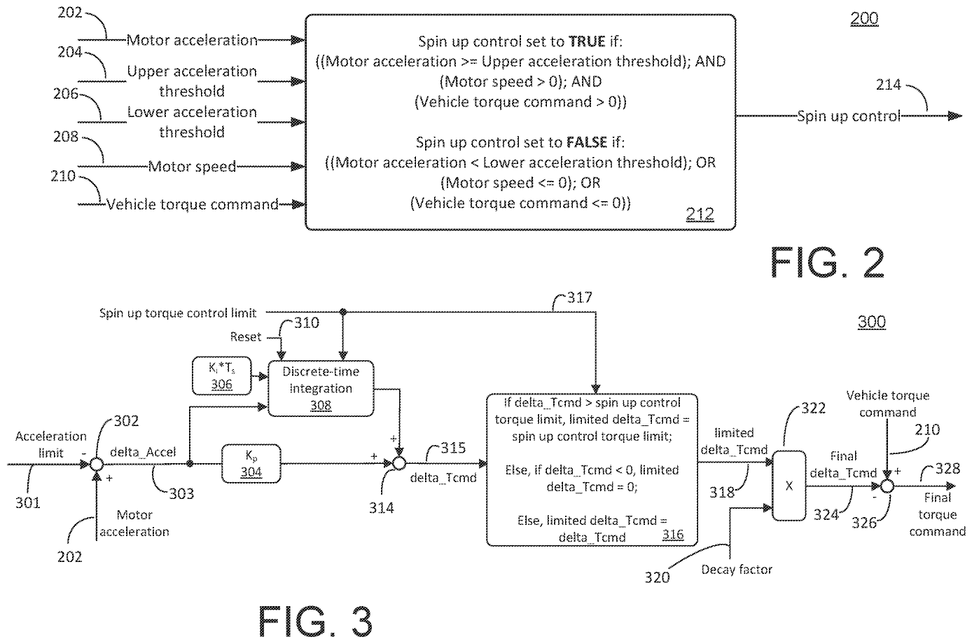

FIG. 2 shows an example 200 of evaluating vehicle operating conditions (e.g., present vehicle operating conditions) for enabling or disabling spin up control that can be performed by the MCU 106 of the vehicle in FIG. 1. For instance, the example 200 can be implemented by software, hardware, and/or firmware that is included in the MCU 106 of the vehicle 100. Accordingly, for purposes of discussion and illustration, the example 200 will be described with further reference to FIG. 1.

In this example, various parameters indicating present operating conditions of the vehicle 100, as well as acceleration thresholds, can be used by the MCU 106 to determine whether spin up control for the motor 102 should be enabled or disabled. As shown in FIG. 2, motor acceleration 202, an upper acceleration threshold 204, a lower acceleration threshold 206, motor speed 208, and a vehicle torque command 210 can be used for an evaluation 212 to determine whether spin up control should be enabled (spin up control 214 set to TRUE) or should be disabled (spin up control 214 set to FALSE). In an example implementation, spin up control 214 can initially be set to, or initialized to FALSE at startup of the vehicle 100.

As noted above, angle measurements from the sensor 120 of the vehicle 100 can be used to determine the motor speed 208 (angular motor speed). In an example implementation, the motor speed 208 can be indicated by a signal (e.g., in the frequency domain) that is filtered, so as to isolate a range of motor speeds that are of interest for implementing spin up control. For instance, a notch filter could be applied or, alternatively, a bandpass filter could be applied. In other approaches, other filtering techniques can be used. Such approaches can also remove unwanted frequency components in the signal indicating the motor speed 208, such as frequency components associated with resonances in a driveline of the vehicle 100. In example implementations, an unfiltered version of the motor speed 208 signal can be used to determine whether to enable or disable spin up control, while a filtered version of the motor speed 208 signal can used when implementing spin up control, such as described herein.

The motor speed 208 (e.g., filtered motor speed) can then be used to determine the motor acceleration 202. For instance, a derivative of consecutive motor speed measurements can be used to determine the motor acceleration 202. In example implementations, the motor speed 208 and the motor acceleration 202 can be continuously updated to reflect present operating conditions of the motor 102 for use in implementing (enabling and disabling) spin up control, as described herein. As with the motor speed 208, the motor acceleration 202 can be a signal that indicates angular motor acceleration (e.g., in the frequency domain), and can be filtered to remove unwanted frequency components, such as process noise associated with vehicle operating dynamics not related to spin up control. In an example implementation, the signal indicating the motor acceleration 202 can be filtered using a second order low pass filter to remove high frequency noise components, such as sensor noise.

In the example 200 of FIG. 2, the upper (motor) acceleration threshold 204 and the lower (motor) acceleration threshold 206 can be predetermined, based on the implementation of the vehicle 100, such as based on coefficients of friction for wheels/tires of the vehicle 100. The thresholds 204 and 206 can define a hysteresis band when implementing spin up control to prevent oscillating between enabling and disabling spin up control due to the motor acceleration 202 dithering above and below a single motor acceleration threshold value. The vehicle torque command 210 can, in this example, be provided by the VCU 118, e.g., based on depression of an accelerator pedal of the vehicle 100.

As shown in FIG. 2, and noted above, the evaluation 212 of whether spin up control 214 (a spin up control flag, a spin up control value, etc.) should be set to TRUE (spin up control enabled) or FALSE (spin up control disabled) can be based on the motor acceleration 202, the upper acceleration threshold 204, the lower acceleration threshold 206, the motor speed 208, and the vehicle torque command 210. In this example, spin up control is set to TRUE if the motor acceleration 202 (filtered motor acceleration) is greater than or equal to the upper acceleration threshold 204 (satisfying the upper hysteresis limit), the motor speed 208 (filtered motor speed) is greater than zero, and the vehicle torque command is greater than zero. That is, if all of these conditions are met, spin up control is enabled (e.g., spin up control 214 is set to TRUE).

Also in this example, spin up control is set to FALSE (e.g., if currently TRUE, indicating the upper acceleration threshold 204 was previously met), or will remain FALSE in response to occurrence of any of the conditions indicated in the evaluation 212 of FIG. 2, e.g., by applying OR logic. In this example, the conditions for setting spin up control 214 to FALSE include the motor acceleration 202 being less than the lower acceleration threshold 206 (satisfying the lower hysteresis limit), the motor speed 208 being less than or equal to zero, or the vehicle torque command 210 being less than or equal to zero. That is, if any of these conditions are met, spin up control is disabled (e.g., spin up control 214 is set to, or remains FALSE).

FIG. 3 shows an example of a spin up control process 300 that can be performed by the MCU 106 of the vehicle in FIG. 1. That is, the example of FIG. 3 can be implemented in the vehicle 100 (e.g., by software, hardware and/or firmware included in the MCU 106) and, accordingly, will also be described with further reference to FIG. 1. In some implementations, implementation of the process 300 (e.g., by the MCU 106) can be enabled or disabled based on the evaluation 212 in FIG. 2, e.g., based, respectively, on whether spin up control 214 is TRUE or FALSE. The process 300 of FIG. 3 is implemented as a regulator controller that includes a proportional integral controller to achieve spin up control. The process 300, when enabled, uses the motor acceleration 202, the upper acceleration threshold 204, the lower acceleration threshold 206 and the vehicle torque command 210 from FIG. 2. For purposes of illustration, those elements are referenced in FIG. 3 with the same reference numbers as in FIG. 2. As with determination of the motor speed 208 and the motor acceleration 202, the process 300 can be continuously performed to implement spin up control when enabled.

As can be seen in FIG. 3, the process 300 includes receiving, at a difference generation operation 302, the motor acceleration 202 (e.g., a present motor acceleration) and an acceleration limit 301. In this example, the acceleration limit 301 can be based on one, or both of the acceleration thresholds 204 and 206, or can be a limit value that is independent of the acceleration thresholds (e.g., is selected for implementing the process 300). As shown in FIG. 3, the difference generator 302 determines a delta_Accel value 303 as a difference between the motor acceleration 202 and the acceleration limit 301.

The delta_Accel value 303 is then provided to a proportional integral (PI) controller where, on a first path, a proportional gain Kₚ is applied to the delta_Accel value 303 at operation 304. Further, on a second path of the PI controller, an integral gain Ki times a sampling time Ts (e.g., sampling time for the motor speed 208 and/or the motor acceleration 202) is applied to the delta_Accel value 303 at operation 306. At operation 308, discrete-time integration 308 is performed based on the delta_Accel value 303, the product from the operation 306 and a spin up torque control limit (e.g., upper limit) 317. As shown, in the process 300, a reset signal 310 can be provided to reset the discrete-time integration of operation 308 (e.g., spin up control 214 is set to FALSE).

In the process 300, the respective outputs of the operation 304 and the operation 308 are both provided to a summation operation 314. The summation operation 314 adds the outputs of the operations 304 and 308 to generate a delta_Tcmd value 315, which indicates a preliminary torque compensation value to be applied to (e.g., subtracted from) the vehicle torque command 210 (e.g., subtracted from the vehicle torque command).

At operation 316, the delta_Tcmd value 315 is evaluated (e.g., by applying torque saturation based on torque command from the VCU 118) to ensure that the delta_Tcmd value 315 is within a desired torque compensation range for the particular implementation. As shown in FIG. 3, the operation 316 includes comparing the delta_Temd value 315 to the spin up torque control limit 317. If the delta_Tcmd value 315 is greater than the spin up torque control limit 317, an output of the operation 316, a limited delta_Temd value 318, is set to the spin up torque control limit 317. Else, however, if the delta_Temd value 315 is less than zero at the operation 316, the limited delta_Tcmd value 318 is set to zero. Else, however, if the delta_Tcmd value 315 is between zero and the spin up control torque limit 317 (e.g., is between a lower torque control limit and an upper torque control limit), at operation 316, the limited delta Temd_value 318 is set to the delta_Temd value 315.

At operation 322 in the process 300, a decay factor 320 is applied to the limited delta_Tcmd value 318 to generate a final delta_Tcmd value 324. Application of the decay factor 320 can facilitate controlled turn off of spin up control, which can reduce impacts on drivability due to quick transitions between spin up control being enabled and disabled. In this example, the final delta_Tcmd value 324 is subtracted from the vehicle torque command 210 at a difference operation 326 to produce a final torque command 328 (e.g., a spin up control compensated torque command) that can be used by the MCU 106 to control an amount of torque applied by the motor 102 to prevent wheel slip.

The examples of FIGS. 2 and 3 can implement spin up control for a single direction of vehicle travel, such as forward travel of a vehicle. As the conditions of the evaluation 212 include the motor speed being greater than zero, the example of FIGS. 2 and 3 would not apply for reverse vehicle operation, where motor speed is represented as a negative value. That is, the example implementations of FIGS. 2 and 3 can be implemented when motor speed, motor acceleration and a vehicle torque command are of the same numeric sign (e.g., all positive, indicating forward travel, forward acceleration and forward torque).

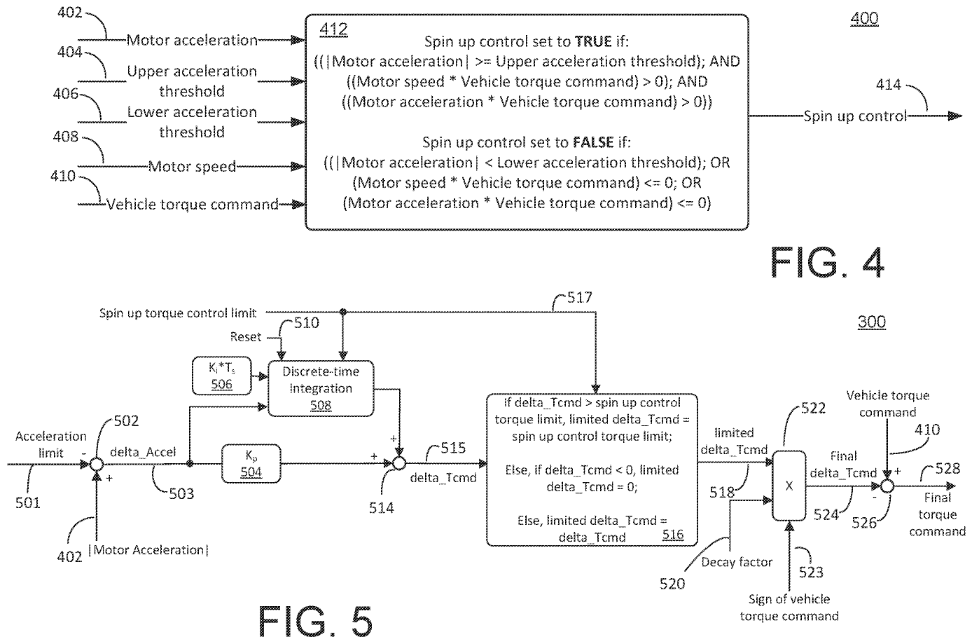

In some implementations, spin up control can be implemented regardless of the direction of vehicle travel. That is, spin up control can be implemented for forward operation of a vehicle, and for reverse operation of a vehicle. In such implementations, enabling spin up control can be based, at least in part, on a determination that motor speed, motor acceleration and a vehicle torque command are all in a same direction, e.g., all have a positive numeric sign, or all have a negative numeric sign. FIGS. 4 and 5 illustrate example approaches for implementing spin up control for both forward vehicle operation and reverse vehicle operation.

FIG. 4 shows an example 400 of evaluating vehicle operating conditions (e.g., present vehicle operating conditions) for enabling or disabling spin up control that can be performed by the MCU 106 of the vehicle in FIG. 1 for both forward vehicle operation and reverse vehicle operation. As with the example 200, the example 400 can be implemented by software, hardware, and/or firmware that is included in the MCU 106 of the vehicle 100. Accordingly, for purposes of discussion and illustration, the example 400 will be described with further reference to FIG. 1.

In this example, as with the examples of FIGS. 2 and 3, various parameters indicating present operating conditions of the vehicle 100, as well as acceleration thresholds, can be used by the MCU 106 to determine whether spin up control for the motor 102 should be enabled or disabled. As shown in FIG. 4, motor acceleration 402, an upper acceleration threshold 404, a lower acceleration threshold 406, motor speed 408, and a vehicle torque command 410 can be used for an evaluation 412 to determine whether spin up control should be enabled (spin up control 414 set to TRUE) or should be disabled (spin up control 414 set to FALSE). In an example implementation, spin up control 414 can initially be set to, or initialized to FALSE at startup of the vehicle 100.

As noted above, angle measurements from the sensor 120 of the vehicle 100 can be used to determine the motor speed 408 (angular motor speed). A positive value for motor speed 408 can indicate forward operation of the motor 102, while a negative value can indicate reverse operation of the motor 102. In an example implementation, the motor speed 408 can be indicated by a signal (e.g., in the frequency domain) that is filtered, so as to isolate a range of motor speeds that are of interest for implementing spin up control. For instance, a notch filter could be applied or, alternatively, a bandpass filter could be applied. In other approaches, other filtering techniques can be used. Such approaches can also remove unwanted frequency components in the signal indicating the motor speed 408, such as frequency components associated with resonances in a driveline of the vehicle 100. In example implementations, an unfiltered version of the motor speed 408 signal can be used to determine whether to enable or disable spin up control, while a filtered version of the motor speed 408 signal can used when implementing spin up control, such as described herein.

The motor speed 408 (e.g., filtered motor speed) can then be used to determine the motor acceleration 402. For instance, a derivative of consecutive motor speed measurements can be used to determine the motor acceleration 402. Positive values for motor acceleration 402 and motor speed 408 can respectively indicate forward acceleration and forward operation of the motor 102, while negative value can respectively indicate reverse acceleration and reverse operation of the motor 102 (e.g., reverse operation, motor braking, etc.). In example implementations, the motor speed 408 and the motor acceleration 402 can be continuously updated to reflect present operating conditions of the motor 102 for use in implementing (enabling and disabling) spin up control, as described herein. The motor acceleration 402 can be a signal that indicates angular motor acceleration (e.g., in the frequency domain) and, as with the motor speed 408, can be filtered to remove unwanted frequency components, such as noise associated with vehicle operating dynamics not related to spin up control. In an example implementation, the signal indicating the motor acceleration 402 can be filtered using a second order low pass filter to remove high frequency noise components, such as sensor noise.

In the example 400 of FIG. 4, the upper (motor) acceleration threshold 404 and the lower (motor) acceleration threshold 406 can be predetermined, based on the implementation of the vehicle 100, such as based on coefficients of friction for wheels/tires of the vehicle 100. The thresholds 404 and 406 can define a hysteresis band when implementing spin up control to prevent oscillating between enabling and disabling spin up control due to the motor acceleration 402 dithering above and below a single motor acceleration threshold value. The vehicle torque command 410 can, in this example, be provided by the VCU 118, e.g., based on depression of an accelerator pedal of the vehicle 100 and direction of operation of the vehicle, e.g., positive for forward vehicle operation and negative for reverse vehicle operation.

As shown in FIG. 4, and noted above, the evaluation 412 of whether spin up control 414 (a spin up control flag, a spin up control value, etc.) should be set to TRUE (spin up control enabled) or FALSE (spin up control disabled) can be based on the motor acceleration 402, the upper acceleration threshold 404, the lower acceleration threshold 406, the motor speed 408, and the vehicle torque command 410.

In this example, spin up control 414 is set to TRUE if an absolute value of the motor acceleration 402 (filtered motor acceleration) is greater than or equal to the upper acceleration threshold 404 (satisfying the upper hysteresis limit), the motor speed 408 (filtered motor speed) multiplied by the vehicle torque command 410 is greater than zero, and the motor acceleration 402 multiplied by the vehicle torque command 410 is greater than zero. That is, if all of these conditions are met, spin up control is enabled (e.g., spin up control 414 is set to TRUE).

Use of the condition of the absolute value of the motor acceleration 402 being greater than or equal to the upper acceleration threshold 404 accounts for both forward and reverse operation of the vehicle 100. Further, the condition of the motor speed 408 multiplied by the vehicle torque command 410 being greater than zero ensures both the motor speed 408 and vehicle torque command 410 are in a same direction (e.g., both forward, or both reverse). Otherwise, their product would be negative, e.g. less than zero. Likewise, use of the condition of the motor acceleration 402 multiplied by the vehicle torque command 410 being greater than zero ensures both the condition the motor acceleration 402 multiplied by the vehicle torque command 410 are also in the same direction (e.g., both forward, or both reverse). That is, application of these conditions for setting spin up control 414 to TRUE ensures that the motor acceleration (forward or reverse) is above the upper acceleration threshold 404, and that the motor acceleration 402, the motor speed 408 and the vehicle torque command 410 are all in a same direction.

Also in this example, spin up control is set to FALSE (e.g., if currently TRUE, indicating the upper acceleration limit 404 was previously met), or will remain FALSE in response to any of the following conditions being met, e.g., by applying OR logic. As shown in FIG. 4, the first condition is the absolute value of the motor acceleration 402 being less than the lower acceleration threshold 406 (satisfying the lower hysteresis limit). The second condition, in this example, includes the motor speed 408 multiplied by the vehicle torque command 410 is less than or equal to zero. The third condition, in this example, includes the motor acceleration 402 multiplied by the vehicle torque command 410 being less than or equal to zero. That is, if any of these three conditions are met, spin up control is disabled (e.g., spin up control 214 is set to FALSE, if not already set to FALSE).

Use of the condition of the absolute value of the motor acceleration 402 being less than the lower acceleration threshold 406 accounts for both forward and reverse operation of the vehicle 100. Further, the condition of the motor speed 408 multiplied by the vehicle torque command 410 being less than or equal zero will set spin up control 414 to FALSE if there is no requested torque, e.g., the vehicle torque command 410 is zero, or if the motor speed 408 and the vehicle torque command 410 are in opposite directions (e.g., one forward and one reverse). Further, the condition of the motor acceleration 402 multiplied by the vehicle torque command 410 being less than or equal zero will set spin up control 414 to FALSE if there is no requested torque, e.g., the vehicle torque command 410 is zero, or if the motor acceleration 402 and the vehicle torque command 410 are in opposite directions (e.g., one forward and one reverse).

FIG. 5 shows an example of a spin up control process 500 that can be performed by the MCU 106 of the vehicle in FIG. 1. That is, the process 500 can be implemented in the vehicle 100 (e.g., by software, hardware and/or firmware included in the MCU 106) and, accordingly, will also be described with further reference to FIG. 1. Implementation of the process 500 can be enabled or disabled based on the evaluation 412 in FIG. 4, e.g., based, respectively, on whether spin up control 414 is TRUE or FALSE. As with the process 300 of FIG. 3, the process 500 of FIG. 5 is implemented as a regulator controller that includes a proportional integral controller to achieve spin up control. The process 500, when enabled, uses an absolute value of motor acceleration 402a (which is the absolute value of the motor acceleration 402 in this example). The process 500, when enabled, also uses the upper acceleration threshold 404, the lower acceleration threshold 406 and the vehicle torque command 410 from FIG. 4. For purposes of illustration, those elements are referenced in FIG. 5 with the same reference numbers as in FIG. 4. As with determination of the motor speed 408 and the motor acceleration 402 (and its absolute value), the process 500 can be continuously performed to implement spin up control when enabled.

As can be seen in FIG. 5, the process 500 includes receiving, at a difference generation operation 502, the absolute value of motor acceleration 402a (e.g., absolute value of a present motor acceleration) and an acceleration limit 501. In this example, the acceleration limit 501 can be based on one, or both of the acceleration thresholds 404 and 406, or can be a limit value that is independent of the acceleration thresholds (e.g., is selected for implementing the process 500). As shown in FIG. 5, the difference generator 502 determines a delta Accel value 503 as a difference between the absolute value of motor acceleration 402a and the acceleration limit 501.

The delta_Accel value 503 is then provided to a proportional integral (PI) controller where, on a first path, a proportional gain Kₚ is applied to the delta_Accel value 503 at operation 504. Further, on a second path of the PI controller, an integral gain Kᵢ times a sampling time Tₛ (e.g., sampling time for the motor speed 408 and/or the motor acceleration 402) is applied to the delta_Accel value 503 at operation 506. At operation 508, discrete-time integration is performed based on the delta_Accel value 503, the product from the operation 506 and a spin up torque control limit (e.g., upper limit) 517. As shown, in the process 500, a reset signal 510 can be provided to reset the discrete-time integration of operation 508 (e.g., when spin up control 414 is set to FALSE).

In the process 500, the respective outputs of the operation 504 and the operation 508 are both provided to a summation operation 514. The summation operation 514 adds the outputs of the operations 504 and 506 to generate a delta_Tcmd value 515, which indicates a preliminary torque compensation value to be applied to, or combined with (e.g., subtracted from or added to) the vehicle torque command 410.

At operation 516, the delta_Tcmd value 515 is evaluated (e.g., by applying torque saturation based on a torque command from the VCU 118) to ensure that the delta_Tcmd value 515 is within a desired torque compensation range for the particular implementation. As shown in FIG. 5, the operation 516 includes comparing the delta_Tcmd value 515 to the spin up torque control limit 517. If the delta_Tcmd value 515 is greater than the spin up control limit 517, an output of the operation 516, a limited delta_Tcmd value 518, is set to the spin up torque control limit 517. Else, however, if the delta_Temd value 515 is less than zero at the operation 516, the limited delta_Tcmd value 518 is set to zero. Else, however, if the delta_Temd value 515 is between zero and the spin up control torque limit 517 (e.g., is between a lower torque control limit and an upper torque control limit), at operation 516, the limited delta_Tcmd value 518 is set to the delta_Temd value 515.

At operation 522 in the process 500, the limited delta_Tcmd value 518 (which can be referred to as an absolute value of a torque compensation amount) is multiplied by a decay factor 520 and a numeric sign of the vehicle torque command 523 to generate a final delta_Tcmd value 524. The numeric sign of the vehicle torque commend 523 accounts for the direction of vehicle operation when implementing spin up control. Application of the decay factor 520 can facilitate controlled turn off of spin up control, which can reduce impacts on drivability due to quick transitions between spin up control being enabled and disabled. In this example, the final delta_Tcmd value 524 is, depending on its sign, subtracted from, or added to the vehicle torque command 410 at a difference operation 526 to produce a final torque command 528 (e.g., a spin up control compensated torque command) that can be used by the MCU 106 to control an amount of torque applied by the motor 102 to prevent wheel slip.

The terms “substantially” and “about” used throughout this Specification are used to describe and account for small fluctuations, such as due to variations in processing. For example, they can refer to less than or equal to ±5%, such as less than or equal to ±2%, such as less than or equal to ±1%, such as less than or equal to ±0.5%, such as less than or equal to ±0.2%, such as less than or equal to ±0.1%, such as less than or equal to ±0.05%. Also, when used herein, an indefinite article such as “a” or “an” means “at least one.”

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein.

A number of implementations have been described. Nevertheless, it will be understood that various modifications may be made without departing from the spirit and scope of the specification.

In addition, the logic flows depicted in the figures do not require the particular order shown, or sequential order, to achieve desirable results. In addition, other processes may be provided, or processes may be eliminated, from the described flows, and other components may be added to, or removed from, the described systems. Accordingly, other implementations are within the scope of the following claims.

While certain features of the described implementations have been illustrated as described herein, many modifications, substitutions, changes and equivalents will now occur to those skilled in the art. It is, therefore, to be understood that appended claims are intended to cover all such modifications and changes as fall within the scope of the implementations. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components and/or features of the different implementations described.

1. A method comprising:
determining, by a motor controller, an angular acceleration of an electric motor of a vehicle;
determining, by the motor controller, an angular speed of the electric motor;
receiving, by the motor controller, a torque command indicating an amount of torque requested from the electric motor; and
in response to the angular acceleration exceeding a first threshold, the angular speed being non-zero, and the amount of torque requested by the torque command being non-zero:
determining a torque compensation amount based on a difference between an acceleration limit and the angular acceleration;
subtracting the torque compensation amount from the amount of torque requested by the torque command to generate a compensated torque command; and
controlling an amount of torque generated by the electric motor using the compensated torque command.

2. The method of claim 1, wherein a numeric sign for the torque compensation amount is based on a numeric sign of the amount of torque requested by the torque command.

3. The method of claim 1, wherein determining the torque compensation amount includes determining the torque compensation amount using a proportional integral controller that is configured to implement a regulator controller.

4. The method of claim 3, wherein the regulator controller is enabled in response to all of:
the angular acceleration exceeding the first threshold;
the angular speed being greater than zero; and
the amount of torque requested by the torque command being greater than zero.

5. The method of claim 3, wherein the regulator controller is enabled in response to all of:
an absolute value of the angular acceleration exceeding the first threshold;
the angular speed multiplied by the amount of torque requested by torque command being greater than zero; and
the angular acceleration multiplied by the amount of torque requested by the torque command being greater than zero.

6. The method of claim 3, wherein the regulator controller is disabled in response to one or more of:
the angular acceleration being less than a second threshold, the second threshold being less than the first threshold;
the angular speed being greater than less than or equal to zero; or
the amount of torque requested by the torque command being less than or equal to zero.

7. The method of claim 3, wherein the regulator controller is disabled in response to one or more of:
an absolute value of the angular acceleration being less than a second threshold, the second threshold being less than the first threshold;
the angular speed multiplied by the amount of torque requested by the torque command being greater than less than or equal to zero; or
the angular acceleration multiplied by the amount of torque requested by the torque command being less than or equal to zero.

8. The method of claim 1, wherein an absolute value of the torque compensation amount is between zero and a torque compensation limit greater than zero.

9. A vehicle comprising:
an electric motor; and
a motor controller configured to:
determine an angular acceleration of the electric motor of a vehicle;
determine an angular speed of the electric motor;
receive a torque command indicating an amount of torque requested from the electric motor; and
in response to the angular acceleration exceeding a first threshold, the angular speed being non-zero, and the amount of torque requested by the torque command being non-zero:
determine a torque compensation amount based on a difference between an acceleration limit and the angular acceleration;
subtract the torque compensation amount from the amount of torque requested by the torque command to generate a compensated torque command; and
control an amount of torque generated by the electric motor using the compensated torque command.

10. The vehicle of claim 9, wherein a numeric sign for the torque compensation amount is based on a numeric sign of the amount of torque requested by the torque command.

11. The vehicle of claim 9, wherein the motor controller includes a proportional integral controller configured to determine the torque compensation amount.

12. The vehicle of claim 11, wherein the proportional integral controller implements a regulator controller.

13. The vehicle of claim 11, wherein the proportional integral controller is enabled in response to all of:
the angular acceleration exceeding the first threshold;
the angular speed being greater than zero; and
the amount of torque requested by the torque command being greater than zero.

14. The vehicle of claim 11, wherein the proportional integral controller is enabled in response to all of:
an absolute value of the angular acceleration exceeding the first threshold;
the angular speed multiplied by the amount of torque requested by torque command being greater than zero; and
the angular acceleration multiplied by the amount of torque requested by the torque command being greater than zero.

15. The vehicle of claim 11, wherein the proportional integral controller is disabled in response to one or more of:
the angular acceleration being less than a second threshold, the second threshold being less than the first threshold;
the angular speed being greater than less than or equal to zero; or
the amount of torque requested by the torque command being less than or equal to zero.

16. The vehicle of claim 11, wherein the proportional integral controller is disabled in response to one or more of:
an absolute value of the angular acceleration being less than a second threshold, the second threshold being less than the first threshold;
the angular speed multiplied by the amount of torque requested by the torque command being greater than less than or equal to zero; or
the angular acceleration multiplied by the amount of torque requested by the torque command being less than or equal to zero.

17. The vehicle of claim 9, wherein an absolute value of the torque compensation amount is between zero and a torque compensation limit greater than zero.
